(19) United States
(12) Patent Application Publication
(10) Pub. No.: US 2006/0193463 A1
(43) Pub. Date: Aug. 31, 2006

(54) Arrangement and method for replacement of program data of a control unit

(76) Inventor: Andreas Graf, Grobenzell (DE)

Correspondence Address: SCHIFF HARDIN, LLP;PATENT DEPARTMENT, 6600 SEARS TOWER, CHICAGO, IL, 60606-6473, US

(21) Appl. No.: 11/358,778

(22) Filed: Feb. 21, 2006

(30) Foreign Application Priority Data
Feb. 28, 2005 (DE) 10 2005 008 952.6

(51) Int. Cl. H04M 3/00; H04M 5/00

(52) U.S. Cl. 379/269

(57) ABSTRACT

In an arrangement and method for replacement of program data stored in a first control unit, the first control unit is connected with at least one second control unit via a data connection. The arrangement also has a first operating system stored in a first storage region of the first control unit. The first control unit executes program steps of a first program element upon execution of the operating system, whereby the first control unit provides at least one operating or control function. The second control unit has at least one storage region in which is stored at least one copy of the first operating system. The first control unit executes a second operating system, whereby upon execution of the second operating system the first control unit executes at least one second program element that reads out the copy of the first operating system that is stored in the storage region of the second control unit and replaces the first operating system stored in the storage region of the first control unit.

### BACKGROUND

The preferred embodiment concerns an arrangement for replacement of program data of a control unit, in which a first control unit is connected with at least one second control unit via a data connection. A first operating system is stored in a storage region of the first control unit, whereby the first control unit executes program steps of a further program element upon execution of the operating system, via which program steps the first control unit provides at least one operating or control function.

For various apparatuses, in particular for printers and copiers, control units (in particular personal computers) are used as control units that are connected with the device controller of the respective device via a data connection. In particular given the use of computers as control units, manifold alterations to the configuration of the installed operating system can occur during the use of the computer. These changes can, for example, occur in the installation of further program elements to be executed with the aid of the control unit and via changes of settings of the operating system by operating personnel.

Configuration settings of a program element for operation or control of the connected apparatus can also be changed such that the program element no longer executes the required operating or control function without errors. It often can also not be precisely established whether the cause for malfunctions lies in the configuration of the operating system or in the configuration of the program element. In order to provide error-free functioning after a malfunction or a crash of the computer and to preclude further malfunctions, the operating system must also be reinstalled and configured. In the event that the program element for provision of at least one operating or control function is also stored in a storage region of the computer and is not loaded from another data source after a restart of the computer, this program element must also be reinstalled on the computer and configured such that the desired operating or control functions can be executed.

The reinstallation of a complete system with the operating system and the further program element for provision of the operating or control function is very complicated, whereby the configuration of the operating system and of the further program element is also often very complicated since it is often difficult to set the correct configuration settings, even for service technicians.

A method and a device system as well as a computer program system for the maintenance of a printing or copying system is known from the document WO 02/088923, in which a printing or copying system has at least two system computers, of which at least one computer is designed as a service connection computer. The service connection computer is connected with a maintenance computer that transfers control programs to the service connection computer.

A computer system for cloning and adaptation of an operating system is known from the document DE 20 2004 009.434 U1.

From the document U.S. Pat. No. 6,591,376 B1, it is known to replace program data of a printer with a newer version of this program data.

### SUMMARY

It is an object to specify an arrangement and a method for replacement of program data of a control unit, via which at least the operating system receives a preset configuration in a simple manner.

In a method or arrangement for replacement of program data stored in a first control unit, data are transferred between the first control unit and at least one second control unit with aid of a data connection. At least one part of instructions contained in program data of a first operating system stored in a boot partition of a storage region of the first control unit are executed with aid of the first control unit, and program steps of at least one first program element are executed, at least one operating or control function being provided upon execution of the first program element. At least one part of the instructions contained in the program data of a second operating system are executed with aid of the first control unit. The instructions contained in the program data of the second operating system are invoked with instructions of a program element stored on an exchangeable data medium, the program data of the second operating system being stored in a further partition of the first control unit. Instructions of the second operating system and program steps of at least one second program element are executed with the first control unit via which a copy of at least the first operating system stored in a storage region of the second control unit is read out, and via which at least the program data of the first operating system stored in the storage region of the first control unit are replaced with the program data contained in the copy.

### BRIEF DESCRIPTION OF THE DRAWINGS

FIG. 1 is a schematic representation of a control panel control unit and a printer control unit with a LAN connection in a first operating state;

FIG. 2 shows the arrangement according to FIG. 1 in a second operating state; and

FIG. 3 shows the arrangement according to FIGS. 1 and 2 in a third operating state.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

Via an arrangement to replace program data of a control unit, it is achieved that at least one image or copy of the operating system is simply loaded from the second control unit into the first control unit and replaces the operating system stored there. A stored, executable configuration of the operating system can thus be simply reproduced, and with this a functioning system for operation and/or control can be provided at least after a restart of the first control unit. In particular a delivery state of at least the operating system can be stored as an image, whereby this delivery state can then simply be reproduced.

A second aspect of the preferred embodiment concerns a method for replacement of program data of a control unit, in that data are transferred between first control units and at least one second control unit with the aid of a data connection. With the aid of the first control unit, at least one part of the instructions contained in the program data of the first operating system is executed in order to provide functions of the first operating system. Program steps of at least one further stored program element are also executed with the aid of the first control unit, whereby at least one operating or control function is provided upon execution of the program steps of the program element.

Upon execution (with the aid of the first control unit) of at least one part of instructions contained in program data of a second operating system, functions of the second operating system are provided and program steps of at least one second program element are executed via which a copy with program data of the first operating system is read out, which copy is stored in a storage region of the second control unit. The program data of the first operating system stored in the storage region of the first control unit are replaced by the program data contained in the copy.

Via such a method, a configuration state (stored as an image) of at least the operating system can be reproduced in a simple manner, such that a defined executable or run-capable configuration state is thereby reproduced. Via the replacement of the first operating system it is ensured that faulty configuration settings are completely replaced by the transferred first operating system, such that further effects of faulty configuration settings can no longer occur.

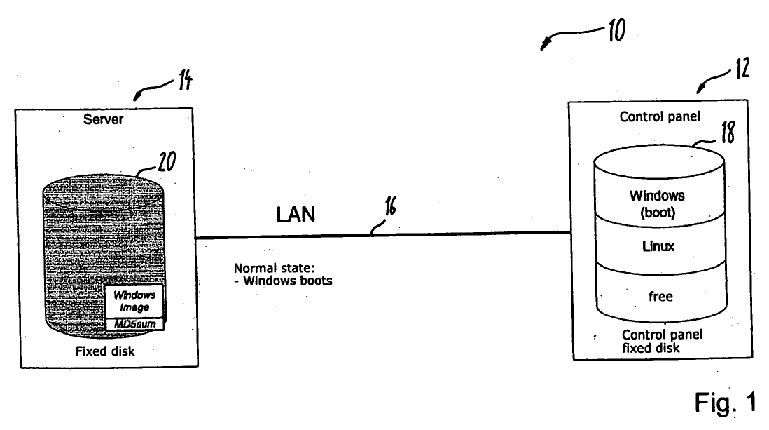

An arrangement 10 is shown in FIG. 1 that shows a control panel control unit 12 and a device control unit 14 of an electrophotographic printer or copier. The control panel control unit and the device control unit 14 are connected with one another via a local area network connection 16 and can exchange data over this data connection 16 for control and operation of the electrophotographic printer or copier. In particular status information as well as setting and measurement values is transferred from the device control unit 14 to the control panel control unit 12, and changed setting values and control commands are transferred from the control panel control unit 12 to the device control unit 14.

Both the device control unit 14 and the control panel control unit 12 are executed as personal computers that contain hard drive (also known as fixed disk) storage in addition to a working memory and a CPU. In the present exemplary embodiment, the hard drive storage 18 of the control panel control unit 12 is sub-divided into at least three partitions. The operating system MS Windows 2000 by the company Microsoft Corporation is stored on a first partition, which is executed as a boot partition. The configuration of this operating system has been adapted to the hardware configuration of the computer of the control panel control unit 12 via an installation routine. An operating system that can be executed by the computer system of the control panel control unit 12 is thereby stored on the first partition of the hard drive 18. Program data of a program for operation of the printer or copier are also stored on this partition. Program data of the operating system Linux in the distribution Suse 9.0 Professional are stored on a second partition of the hard drive storage 18 and configured such that they can be executed with the aid of the control panel control unit 12. However, the second partition of the hard drive storage 18 is not bootable, such that the operating system Linux stored there can only be started with the aid of further program elements. The hard drive storage 18 furthermore has a third partition in which data can be cached.

The second control unit 14 likewise has a hard drive (also known as fixed disc) 20 on which is stored (in addition to program data for control of the printer or copier) a copy or image of the first partition of the hard drive storage 18 of the control panel control unit 12 in a delivery state of the control panel control unit 12. This copy has thus advantageously been generated before the delivery of the control panel control unit 12 from the first partition of the hard drive 18 and transferred to the hard drive storage 20 of the device control unit 14. This copy is advantageously stored encrypted in a file in order to preclude manipulations and in order to be able to detect transfer errors.

The device control unit 14 also serves as a server for the control panel control unit 12, since the device control unit 14 provides at least all setting values and operating data of the printer or copier for recall by the control panel control unit 12. Additionally, it is also typical to transfer the program data for generation of a graphical user interface with the aid of the control panel control unit 12 from the device control unit 14 over the data connection 16 to the control panel control unit 12 and, for example, to display them in what is known as a browser program module. For this purpose, the device control unit 14 can contain an HTTP server to provide program data for generation of a graphical user interface. These program data can, for example, contain a hypertext that is executed with the aid of what is known as a browser program module (such as, for example, Internet Explorer 6 by the company Microsoft Corporation) that is executed with the aid of the control panel control unit 12, whereby a graphical user interface is output on a display unit of the control panel control unit 12. In such a case, it is no longer absolutely necessary to store the program element for provision of the at least one operating or control function in a storage region of the first partition of the hard drive storage 18 or in another storage region of the control panel control unit 12.

In the operating state shown in FIG. 1, the control panel control unit 12 is configured such that the operating system MS Windows 2000 stored in the first partition is started after the start of the control panel control unit 12 for example after the activation of the computer of the control panel control unit 12. The operating system. MS Windows 2000 is thereby configured such that, after the start of operating system components, the browser program module is automatically started and an HTML document is subsequently automatically loaded from the device control unit 14 serving as a server. Alternatively or additionally, what are known as JAVA applets can be transferred from the fixed disk 20 of the device control unit 14 to the control panel control unit 12 and be executed by the operating system MS Windows 2000 running there and what is known as a Java Runtime Environment or a Java Web Start program element. The second partition and the third partition of the hard drive storage 18 of the control panel control unit 12 are not used in this operating mode, meaning that no accesses occur to these partitions.

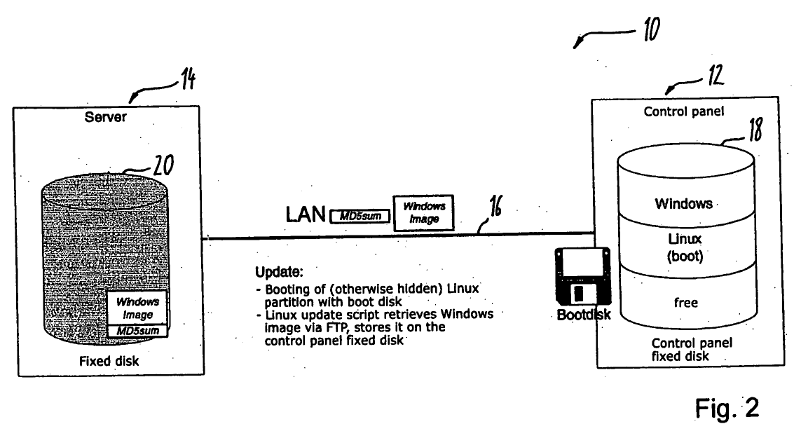

The arrangement according to FIG. 1 is shown in FIG. 2. Identical elements have the same reference characters. The arrangement 10 is operated in the second operating mode shown in FIG. 2, such that the control panel control unit 12 is started with the aid of what is known as a boot diskette that contains program elements, upon whose execution the program data stored in the second partition of the hard drive storage 18 of the control panel control unit 12 are loaded and the instructions contained in these program data are executed. The control panel control unit 12 is thereby started with the operating system Linux (in the distribution Suse 9.0 Professional) stored in the second partition. After the loading and execution of the program elements of the operating system Linux, this operating system Linux is executed with the aid of the control panel control unit 12 and the necessary functions and program elements of the operating system Linux are provided.

At least one script with further instructions is subsequently, advantageously automatically, loaded and executed. Such a script is advantageously a Perl script. With the aid of this Perl script, at least one program element of the operating system Linux receives instructions to read out the copy (stored in a region of the hard drive storage 20 of the device control unit 14) of an earlier version of the first partition of the hard drive storage 18 from the storage region of the hard drive storage 20, to transfer it over the data connection 16 to the control panel control unit 12 and to temporarily store it in the third partition of the hard drive storage 18. The copy of the first partition (which copy is stored in a storage region of the hard drive storage 20), also designated as a Windows image, comprises a checksum that is transferred together with the copy to the control panel control unit 12 and is stored in the third partition of the hard drive storage 18. The readout and transfer of the copy advantageously occurs with the aid of what is known as a file transfer protocol (FTP).

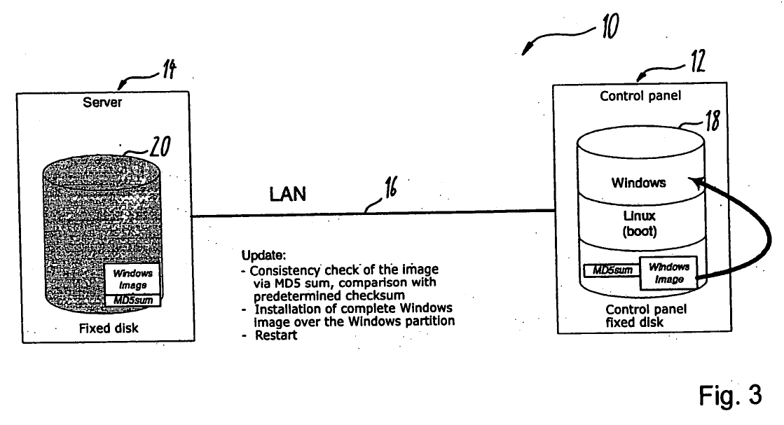

The arrangement 10 according to FIGS. 1 and 2 is shown in FIG. 3 in an operating state in which a checksum of the copy is re-determined and compared with the transferred checksum with the aid of the Perl script. Given a positive comparison result, the operating system stored in the first partition and the further program elements are overwritten with program data contained in the copy, whereby all program data and all settings that are stored in the first partition of the hard drive storage 18 of the control panel control unit 12 are replaced by the program data and configuration settings contained in the transferred copy. The copy stored in the storage region of the hard drive storage 20 of the device control unit 14 advantageously contains program data of the delivery state of the control panel control unit 12.

Alternatively, another suitable configuration state of the MS Windows 2000 operating system can also be alternatively or additionally stored as a copy in a storage range of the hard drive storage 20. In particular a copy of a structurally identical control panel control unit can be stored in the storage region of the hard drive storage 20 and be stored on an empty hard drive partition, advantageously an empty boot partition. The installation complexity to install and configure the operating system of the control panel control unit 12 can thereby be significantly reduced.

Alternatively, a plurality of copies with various configuration states can also be stored in a storage region of the hard drive storage 20 of the device control unit 14, from which a suitable configuration state is then selected automatically with the aid the script executed by the control panel control unit 12 or with the aid of an input by an operating personnel. Additionally, before the replacement of the operating system in the first partition of the hard drive storage 18 of the control panel control unit 12, a virus check of this partition or of the entire hard drive storage 18 can be implemented. At least the first partition of the hard drive storage 18 can also be reformatted. Such and further suitable measures to rebuild the operating system of the control panel control unit 12 are known from the international patent application WO 02/088923 A2, whose content is herewith incorporated by reference into the present specification.

Other exchangeable data media (such as, for example, a CD-R, a CD-RW, a DVD-R, a DVD-RW, a DVD-RAM a MO disk or a data medium connected with the control panel control unit 12 via a suitable medium) can also be used as an alternative to the boot diskette for starting the operating system stored in the second partition. Such a data medium connected with an interface can, for example, be a USB stick or a portable hard drive. The described method is suitable in the same manner to replace any other operating system and/or program element contained in a storage region of the hard drive storage 18 of the control panel control unit 12. In general, any program data can be transferred into a storage region of the hard drive storage 18 and stored there with the aid of the copy stored in the storage region of the hard drive storage 20 of the device control unit 14.

The second operating system, with which a further program element for loading of the image stored in a storage region of the hard drive storage 20 of the device control unit 14 and overwriting of program data of the operating system stored in a storage region of the hard drive storage 18, can also be an arbitrary other operating system; it can in particular be the same operating system version that should be replaced with the aid of the copy. For example, program data of the operating system MS Windows 2000 can be both stored in the first partition and in the second partition, whereby the program data stored in the second partition are not used for normal operation of the control panel control unit 12. Rather, the operating system stored in the second partition of the hard drive storage 18 can only be accessed and started with program data stored on a further additional data medium. The Perl script and/or other program or configuration data of the operating system Linux can also be replaced or changed with data stored in a storage region of the hard drive storage 20 or transferred to the control panel control unit 12 over a further data connection (not shown), in particular over a wide area network. These program elements and/or scripts can thereby simply be adapted; in particular errors can be corrected.

The method of the preferred embodiment is in particular suited to be realized at least in part from computer programs. This computer program can be distributed as a file on a data medium such as, for example, a diskette or a CD-ROM or as a file over a data and communication network. Such computer program products or computer program elements with method steps are embodiments of the preferred embodiment. The method can be applied in another control unit of a print device or in a component of a printing system with upstream or downstream data processing devices. It is thus self-evident that corresponding computers, data processing systems and control units that are used for implementation of the preferred embodiment can contain further known technical devices such as an input unit (in particular mouse, keyboard, touchscreen), a microprocessor, a data and/or control bus, a display device (in particular monitor or display) as well as a working memory, a fixed disk storage and a network card.

The device control unit 14 is arranged in the printer or copier. The control panel control unit 12 can be designed as a separate structural unit or be integrated into the housing of the printer or copier. The preferred embodiment can be used in any printers or copiers and in particular is not limited to electrophotographic printers or copiers.

While the invention has been illustrated and described in detail in the drawings in the above description, the same is to be considered as illustrative and not restrictive in character, it being understood that only the preferred embodiment has been shown and described and that all changes and modifications that come within the scope of the invention are desired to be protected.

I claim as my invention:

1. An arrangement for replacement of program data stored in a first control unit, comprising:
the first control unit being connected with at least one second control unit via a data connection;
program data of a first operating system stored in a boot partition of a storage region of the first control unit, the first control unit executing program steps of a first program element upon execution of at least one part of instructions contained in the program data of the first operating system, the first control unit providing at least one operating or control function;
the second control unit having at least one storage region in which is stored at least one copy of at least program data of the first operating system;
program data of a second operating system stored in a further partition of the storage region of the first control unit, instructions contained in the program data of the second operating system being recalled with aid of instructions of a program element stored on an exchangeable data medium; and
the first control unit executing instructions of the second operating system and at least a copy one second program element that reads out at least the copy of the first operating system stored in the storage region of the second control unit and replaces at least the program data of the first operating system stored in the storage region of the first control unit with the program data contained in the copy.

2. An arrangement according to claim 1 wherein the copy stored in the second control unit contains a configuration of the first operating system that can be processed with aid of the first control unit.

3. An arrangement according to claim 1 wherein the stored copy comprises a system recovery backup of at least one part of the storage region of the first control unit.

4. An arrangement according to claim 1 wherein the copy is stored in a file.

5. An arrangement according to claim 1 wherein the copy additionally contains a further program element with instructions for provision of an operating or control function.

6. An arrangement according to claim 1 wherein the copy is transferred to the first control unit, a version state or authenticity of the copy being checked with aid of a program element executed with the first control unit.

7. An arrangement according to claim 1 wherein the first or the second storage regions are respectively contained on a fixed disc.

8. An arrangement according to claim 1 wherein the first control unit has a further storage region in which the transferred image is buffered, said further storage region being a separate partition on a fixed disc.

9. An arrangement according to claim 1 wherein the first control unit has a further storage region in which the program data of the second operating system are stored, this further storage region comprising a separate partition on a fixed disc.

10. An arrangement according to claim 1 wherein before execution of the instructions contained in the program data of the first operating system, the first control unit checks whether at least one program element is stored on an exchangeable data medium, and via said program element the first control unit executes the instructions of the second operating system instead of the instructions of the first operating system.

11. An arrangement according to claim 10 wherein the program data of the second operating system is stored on the data medium or on a further exchangeable data medium.

12. An arrangement according to claim 10 wherein the program data of the second operating system are stored in a further storage region of the first control unit, and the instructions contained in the program data of the second operating system are recalled with aid of instructions of the program element stored on the exchangeable data medium.

13. An arrangement according to claim 10 wherein the exchangeable data medium comprises a diskette, a CD, a DVD, an MO disk, a memory card, or a storage that can be connected with an interface of the first control unit.

14. An arrangement according to claim 1 wherein the first or the second control unit comprises a data processing system.

15. An arrangement according to claim 1 wherein the data connection comprises a network connection between the first control unit and the second control unit.

16. A method for replacement of program data stored in a first control unit, comprising the steps of:
transferring data between the first control unit and at least one second control unit with aid of a data connection;
executing at least one part of instructions contained in program data of a first operating system stored in a boot partition of a storage region of the first control unit with aid of the first control unit, and executing program steps of at least one first program element, whereby at least one operating or control function is provided upon execution of the first program element;
executing at least one part of the instructions contained in program data of a second operating system with aid of the first control unit;
invoking the instructions contained in the program data of the second operating system with aid of instructions of a program element stored on an exchangeable data medium, the program data of the second operating system being stored in a further partition of the first control unit; and
executing instructions of the second operating system and program steps of at least one second program element with aid of the first control unit, via which a copy of at least the first operating system stored in a storage region of the second control unit is read out, and via which at least the program data of the first operating system stored in the storage region of the first control unit are replaced with the program data contained in the copy.

17. An arrangement for replacement of program data stored in a first control unit, comprising:
the first control unit being connected with at least one second control unit via a data connection;
a first operating system stored in a first storage region of the first control unit, the first control unit executing program steps of a first program element upon execution of the first operating system, the first control unit providing at least one operating or control function;
the second control unit having at least one storage region in which is stored at least one copy of the first operating system; and
the first control unit executing a second operating system and executing at least one second program element that reads out the copy of the first operating system stored in the storage region of the second control unit and replaces the first operating system stored in the storage region of the first control unit.
